(19) United States
(12) Patent Application Publication
(10) Pub. No.: US 2011/0019827 A1
(43) Pub. Date: Jan. 27, 2011

(54) INFORMATION PROCESSING APPARATUS

(76) Inventor: Junji Kurihara, Kokubunji-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/823,684

(22) Filed: Jun. 25, 2010

(30) Foreign Application Priority Data
Jul. 24, 2009 (JP) 2009-173746

(51) Int. Cl. H04K 1/04

(52) U.S. Cl. 380/287

(57) ABSTRACT

An information processing apparatus includes: a plurality of digital broadcast stream data descramblers configured to receive broadcast streams and to output descrambled data by descrambling the broadcast streams; a block data buffer configured to buffer access requests output from the digital broadcast stream data descramblers to a B-CAS card per B-CAS access block units; and an arbiter configured to arbitrate the B-CAS card access requests.

### CROSS-REFERENCE TO THE RELATED APPLICATION(S)

The present application is based upon and claims priority from prior Japanese Patent Application No. 2009-173746, filed on Jul. 24, 2009, the entire contents of which are incorporated herein by reference.

### BACKGROUND

1. Field

The present invention relates to an information processing apparatus, and more particularly, to a digital broadcast receiving system for arbitrating the B-CAS card access requests of plural channels using hardware.

2. Description of the Related Art

In a case that a single digital broadcast receiving apparatus receives the digital broadcast stream data of plural channels, it is necessary to resolve competition in the access from plural broadcast stream data descramblers to a B-CAS card. As related art methods proposed for arbitrating the access to a B-CAS card, methods for performing arbitration using software premised on the use of semaphores and interrupts are available. Examples of such methods are disclosed in JP-A-2008-042398 and JP-A-2008-135981 (corresponding U.S. publication is: US 2008/0127274 A1). In these arbitration methods using software, overhead occurs inevitably due to register polling and interrupt processing time. As a result, digital broadcast stream data channels cannot be increased up to the upper limit of the frequency band of the B-CAS I/F.

For example, the publication, JP-A-2008-135981, discloses an information processing apparatus capable of simultaneously reproducing plural encrypted content data using a simple configuration while preventing hacking via a user access bus.

However, since a transaction is issued to an IC card after the software of control processor units makes an inquiry to an arbiter, there is a problem that overhead is large at the time of IC card/master switching.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a view showing a block configuration (3 to 1 arbitration, B-CAS card×1) according to an embodiment of the present invention.

FIG. 2 is a view showing a block configuration (3 to 1 arbitration, B-CAS card×3) for describing advantages of another embodiment of the present invention.

FIG. 3 is a view showing a block configuration of a host-card connection table according to the embodiment.

### DETAILED DESCRIPTION

An embodiment according to the present invention will be described in detail with reference to the accompanying drawings. The scope of the claimed invention should not be limited to the examples illustrated in the drawings and those described below.

### First Embodiment

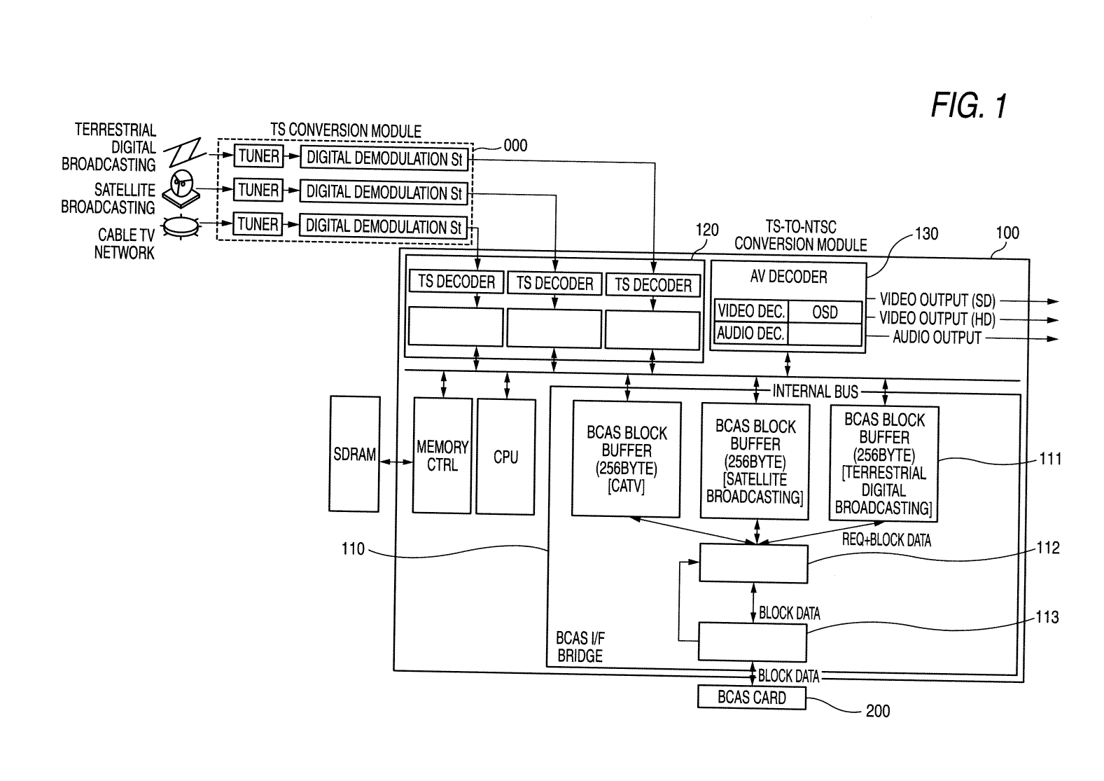

A first embodiment according to the present invention will be described referring to FIG. 1.

FIG. 1 is a view showing a block configuration according to the first embodiment (3 to 1 arbitration) of the present invention.

A TS conversion module (000) receives and digitally demodulates broadcast waves from terrestrial digital broadcasting, satellite broadcasting and CATV and outputs demodulated signals as encrypted transport streams (TSs)

A TS-to-NTSC conversion module (100) receives the encrypted TSs input from the TS conversion module (000) using TS/DS units (transport stream data decoder/data descrambler units) (120), takes out data from the TSs and outputs descrambled video/audio data as video/audio signals from an AV decoder (130) via a B-CAS I/F bridge (110) while inquiring a B-CAS card (200) about keys, etc.

The B-CAS I/F bridge (110) is used to bridge internal bus signals to the B-CAS card (200) via B-CAS access block buffers (111), a request arbiter (112) and a protocol manager (113).

When a request block is held in one of the B-CAS access block buffers (111), a B-CAS card access request is generated. In the case that requests from plural B-CAS access block buffers (111) compete, the request arbiter (112) selects a card accessible request on the basis of the order of priority according to arbitration timing output from the protocol manager (113). The order of priority should only be determined by a method, such as round-robin. The request arbiter (112) and the protocol manager (113) can be configured relatively easily using flip-flop and combinational/sequential circuits.

In the case that another precedent transaction occupies the B-CAS card, an access request buffered in one of the block buffers (111) is arbitrated immediately after the precedent transaction is completed and can access the B-CAS card without software control.

The protocol manager (113) manages the transmission of a request block to the B-CAS card (200) and the reception of a response block therefrom as one transaction and outputs arbitration timing to the request arbiter (112) at the boundary of the transaction.

The B-CAS access block buffers (111) are used as temporary storage areas for request and response blocks.

B-CAS access blocks (request and response blocks) herein have a format described below.
NAD (1 byte): node address
PCB (1 byte): protocol control byte
LEN (1 byte): payload length
INF (0 to 254 bytes): information
PARITY (1 byte)

Hence, the B-CAS access block buffer (111) is required to have a size of not less than 258 bytes.

### Second Embodiment

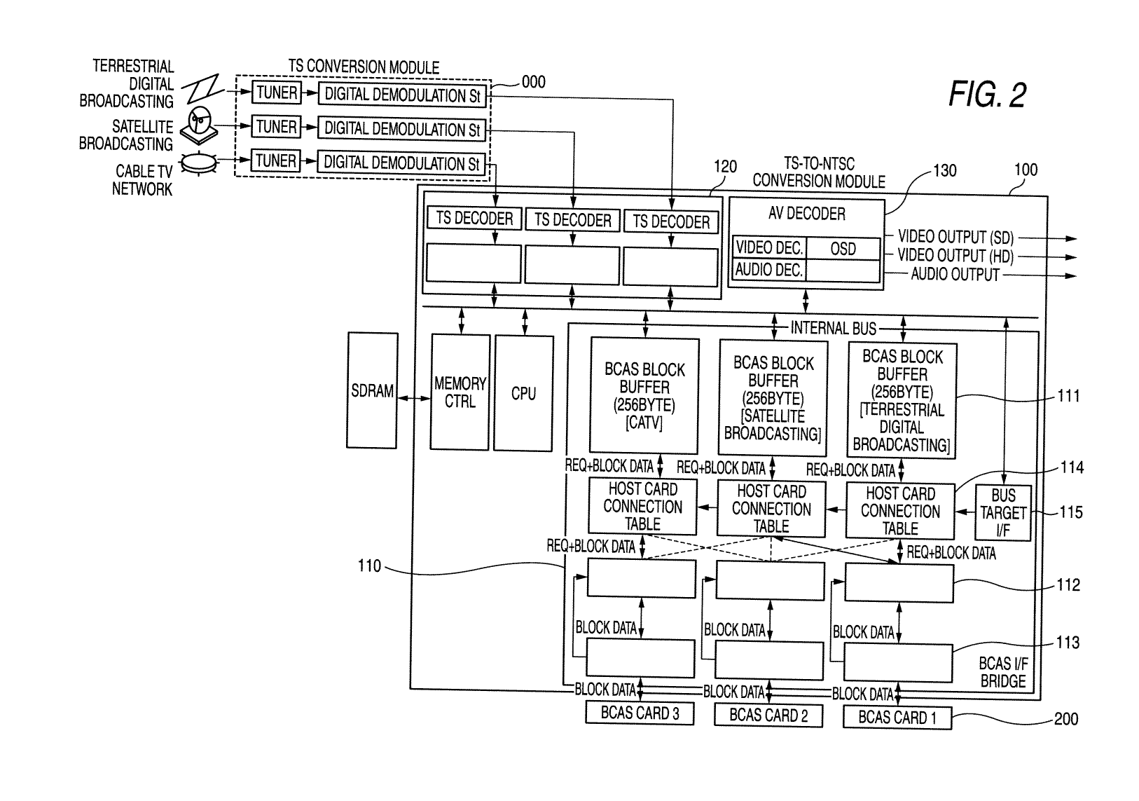

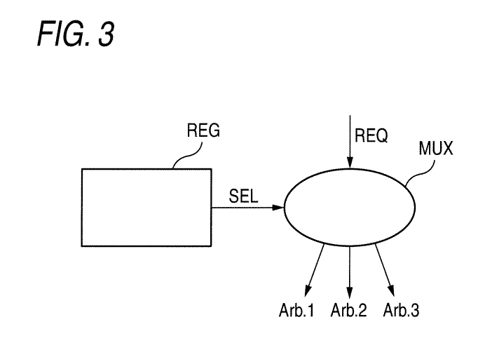

A second embodiment according to the present invention will be described referring to FIGS. 2 and 3.

FIG. 2 is a view showing a block configuration (3 to 1 arbitration, B-CAS card×3) according to this proposed embodiment.

A TS conversion module (000) receives and digitally demodulates broadcast waves from terrestrial digital broadcasting, satellite broadcasting and CATV and outputs demodulated signals as encrypted transport streams (TSs)

A TS-to-NTSC conversion module (100) receives the encrypted TSs input from the TS conversion module (000) using TS/DS units (transport stream data decoder/data descrambler units) (120), takes out data from the TSs and outputs descrambled video/audio data as video/audio signals from an AV decoder (130) via a B-CAS I/F bridge (110) while inquiring B-CAS cards (200) about keys, etc.

The B-CAS I/F bridge (110) is used to bridge internal bus signals to the B-CAS cards (200) via B-CAS access block buffers (111), host-card connection tables (114), request arbiters (112) and protocol managers (113).

When a request block is held in one of the B-CAS access block buffers (111), a B-CAS card access request is generated.

In the case that requests from plural B-CAS access block buffers (111) compete, the request arbiter (112) connected to the B-CAS access block buffer (111) on the basis of the setting of the host-card connection tables (114) selects a card-accessible request on the basis of the order of priority according to arbitration timing output from the protocol managers (113).

Even in the case that another precedent transaction occupies one of the B-CAS cards, an access request buffered in one of the block buffers (111) is arbitrated immediately after the precedent transaction is completed and can access the B-CAS card without software control.

Each protocol manager (113) manages the transmission of a request block to the B-CAS card (200) and the reception of a response block therefrom as one transaction and outputs arbitration timing to the request arbiter (112) at the boundary of the transaction.

The B-CAS access block buffers (111) are used as temporary storage areas for request and response blocks.

The host-card connection tables (114) are set by a CPU via a bus target I/F (115) before request blocks are set in the B-CAS access block buffers (111).

FIG. 3 shows the host-card connection table (114) according to this embodiment. The table divides data (REQ) from the block buffer (111) connected thereto into several blocks, for example, and outputs the data to one of the request arbiters (112). It is configured that the selection of one of the request arbiters (112) to which the data is output at this time is indicated using a select signal that is output from the CPU and held in a register REG and supplied to an MUX (divider) as SEL.

In the above-mentioned embodiments, a method is adopted in which the block buffers, the request arbiters and the protocol managers are disposed on the side of the B-CAS cards, and B-CAS card/master switching is done without software intervention.

An efficient B-CAS card access method for performing B-CAS access competition arbitration using hardware is attained.

(1) A digital broadcast receiving system in which B-CAS card access requests from plural digital broadcast stream data descramblers are arbitrated in B-CAS access block units using hardware (block data buffers and arbiters).

(2) A digital broadcast receiving system having request arbiters and protocol managers as arbitration hardware for the system (1).

(3) A system in which plural digital broadcast stream data descramblers are connected to plural B-CAS cards on the basis of the configuration of the system (1).

As described above, efficient B-CAS card access can be attained by performing B-CAS access competition arbitration using hardware according to the embodiments. Hence, the addition of digital broadcast stream data channels is made possible up to the upper limit of the frequency band of B-CAS I/F.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in one of the embodiments may be removed or the constituent components disclosed in different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a plurality of digital broadcast stream data descramblers configured to receive broadcast streams and to output descrambled data by descrambling the broadcast streams;
a block data buffer configured to buffer access requests output from the digital broadcast stream data descramblers to a B-CAS card per B-CAS access block units; and
an arbiter configured to arbitrate the B-CAS card access requests.

2. The apparatus of claim 1,
wherein the arbiter comprises a request arbiter configured to arbitrate requests and a protocol manager configured to perform protocol management.

3. An information processing apparatus comprising:
a plurality of digital broadcast stream data descramblers configured to receive broadcast streams and to output descrambled data by descrambling the broadcast streams;
a block data buffer configured to buffer access requests output from the digital broadcast stream data descramblers to a B-CAS card per B-CAS access block units;
an arbiter configured to arbitrate the B-CAS card access requests;
a connection table configured to intervene between the block data buffers and the arbiter for transferring block data.

4. The apparatus of claim 3,
wherein the arbiter comprises a request arbiter configured to arbitrate requests and a protocol manager configured to perform protocol management.
